(19) United States
(12) Patent Application Publication
(10) Pub. No.: US 2018/0367182 A1
(43) Pub. Date: Dec. 20, 2018

(54) METHOD AND DEVICE FOR MANUFACTURING CURVED GLASS FOR SCREEN PROTECTOR

(71) Applicant: Wing Tak Lee Silicone Rubber Technology (Shenzhen) Co., Ltd, Shenzhen (CN)

(72) Inventor: Tak Nam LIU, Shenzhen (CN)

(21) Appl. No.: 15/627,452

(22) Filed: Jun. 20, 2017

(51) Int. Cl. H04B 1/3888; C03B 23/03; C03B 23/023; H04M 1/02

(52) U.S. Cl. CPC H04B 1/3888; C03B 23/03; B32B 17/10678; H04M 1/0266; C03B 23/0235

(57) ABSTRACT

The present invention provides a method for manufacturing a curved glass for a screen protector. The method comprises the steps of: receiving, by a curved screen protector manufacturing device, a mould comprising a flat glass; transporting the mould into a first heating tank to heat all sides of the mould for a first predetermined duration; transporting, by the curved screen protector manufacturing device, the mould heated for the first predetermined duration into a second heating tank to heat all of the sides of the mould for a second predetermined duration; transporting, by the curved screen protector manufacturing device, the mould heated for the second predetermined duration to a pressure stabilizing device to stabilize pressure of the mould for a third predetermined duration; and cooling, by the curved screen protector manufacturing device, the mould with the stabilized pressure for the third predetermined duration to obtain a curved glass.

### TECHNICAL FIELD

The present invention relates to the field of terminal accessories, and in particular, relates to a method and device for manufacturing a curved glass for a screen protector.

### BACKGROUND

Terminals, in particular, mobile phones, are commonly used devices of users. With the development of mobile screens, conventional mobile phone screens have evolved to curve screens, such that screen protectors also involve into curve surfaces, referred to as curve-surface screen protectors.

For the curve-surface screen protectors, manufacturing of curve surfaces is most complicated and time consuming. The manufacturing process of the conventional curve glass is based on entire heating, bending and molding of the flat glass. Such technical solution takes long heating time and high energy consumption and has low efficiency since the entire flat glass needs to be heated and bent to mold the curve glass.

### SUMMARY

Embodiments of the present invention provide a method for manufacturing a curved glass for a screen protector, which may reduce heating time, lower power consumption and improve efficiency.

To solve the above technical problem, an embodiment of the present invention provides a method for manufacturing a curved glass for a screen protector. The method comprises the steps of: receiving, by a curved screen protector manufacturing device, a mould comprising a flat glass, and transporting the mould into a first heating tank to heat all sides of the mould for a first predetermined duration; transporting, by the curved screen protector manufacturing device, the mould heated for the first predetermined duration into a second heating tank to heat all of the sides of the mould for a second predetermined duration; transporting, by the curved screen protector manufacturing device, the mould heated for the second predetermined duration to a pressure stabilizing device to stabilize pressure of the mould for a third predetermined duration; and cooling, by the curved screen protector manufacturing device, the mould with the stabilized pressure for the third predetermined duration to obtain a curved glass.

Preferably, the step of cooling, by the curved screen protector manufacturing device, the mould with the stabilized pressure for the third predetermined duration to obtain a curved glass comprises a step of: subjecting, by the curved screen protector manufacturing device, the mould with the stabilized pressure to multi-stage cooling for the third predetermined duration to obtain the curved glass.

Preferably, the multi-stage cooling is five-stage cooling or cooling with more than five stages.

Preferably, the step of subjecting, by the curved screen protector manufacturing device, the mould with the stabilized pressure to multi-stage cooling for the third predetermined duration to obtain the curved glass comprises the steps of: calculating, by the curved screen protector manufacturing device, a duration for the five-stage cooling according to a set temperature corresponding to the second predetermined duration and a room temperature.

Preferably, the step of calculating, by the curved screen protector manufacturing device, a duration for the five-stage cooling according to a set temperature corresponding to the second predetermined duration and a room temperature comprises the steps of: acquiring a temperature interval between the set temperature and the room temperature; dividing the temperature interval into n groups, with each of the n groups comprising five temperature sub-intervals; and calculating a total duration of the five temperature sub-intervals of each of the n groups. The step of calculating a total duration of the five temperature sub-intervals of each of the n groups comprises the steps of: calculating five sub-durations corresponding to the five temperature sub-intervals according to temperatures of the five temperature sub-intervals and temperature slopes corresponding to the five temperature sub-intervals; repeatedly calculating the total duration of the five temperature sub-intervals of each of the n groups by using a sum of the five sub-durations as the total duration of the five temperature sub-intervals to obtain n total durations; and selecting the five sub-durations of the five temperature sub-intervals corresponding to a minimum duration from the n total durations as the duration for the five-stage cooling. The n groups are obtained by the steps of: acquiring four border ranges of the five temperature sub-intervals; assigning a plurality of border points for the four border ranges according to a predetermined temperature interval; and subjecting the plurality of border points within the four border ranges to permutation and combination to obtain the n groups.

Another embodiment of the present invention provides a device for manufacturing a curved screen protector. The device comprises: a receiving part, configured to receive a mould comprising a flat glass; a first heating part, configured to transport the mould into a first heating tank to heat all sides of the mould for a first predetermined duration; a second heating part, configured to transport the mould heated for the first predetermined duration into a second heating tank to heat all of the sides of the mould for a second predetermined duration; a pressure stabilizing part, configured to transport the mould heated for the second predetermined duration to a pressure stabilizing device to stabilize pressure of the mould for a third predetermined duration; and a cooling part, configured to cool the mould with the stabilized pressure for the third predetermined duration to obtain a curved glass.

Preferably, the pressure stabilizing part is further configured to subject the mould with the stabilized pressure to multi-stage cooling for the third predetermined duration to obtain the curved glass.

Preferably, the multi-stage cooling is five-stage cooling or cooling with more than five stages.

Preferably, the cooling part is further configured to calculate a duration for the five-stage cooling according to a set temperature corresponding to the second predetermined duration and a room temperature.

Preferably, the cooling part is further configured to acquire a temperature interval between the set temperature and the room temperature, divide the temperature interval into n groups with each of the n groups comprising five temperature sub-intervals, and calculate a total duration of the five temperature sub-intervals of each of the n groups. The total duration of the five temperature sub-intervals is calculated by: calculating five sub-durations corresponding to the five temperature sub-intervals according to temperatures of the five temperature sub-intervals and temperature slopes corresponding to the five temperature sub-intervals; repeatedly calculating the total duration of the five temperature sub-intervals of each of the n groups by using a sum of the five sub-durations as the total duration of the five temperature sub-intervals to obtain n total durations; and selecting the five sub-durations of the five temperature sub-intervals corresponding to a minimum duration from the n total durations as the duration for the five-stage cooling. The n groups are obtained by: acquiring four border ranges of the five temperature sub-intervals, assigning a plurality of border points for the four border ranges according to a predetermined temperature interval, and subjecting the plurality of border points within the four border ranges to permutation and combination to obtain the n groups.

Persons of ordinary skill in the art would know that although the description is given hereinafter with reference to the embodiments and accompanying drawings, the present invention is not limited to these embodiments. Instead, the scope of the present invention is extensive, and the scope of the present invention is defined by the appended claims.

### BRIEF DESCRIPTION OF THE DRAWINGS

To describe embodiments of the present invention or the technical solution in the related art, hereinafter, drawings that are to be referred for description of the embodiments or the related art are briefly described. Apparently, the drawings described hereinafter merely illustrate some embodiments of the present invention. Persons of ordinary skill in the art may also derive other drawings based on the drawings described herein without any creative effort.

FIG. 1 is a schematic flowchart of a method for manufacturing a curved glass for a screen protector according to a preferred embodiment of the present invention;

FIG. 2A is a schematic diagram of a heating area of a curved glass in the prior art;

FIG. 2B is a schematic diagram of a heating area of a curved glass according to a preferred embodiment of the present invention; and

FIG. 3 is a schematic structural diagram of hardware of a device for manufacturing a curved screen protector according to a preferred embodiment of the present invention.

### DETAILED DESCRIPTION

The technical solutions in the embodiments of the present invention are described in detail clearly and completely hereinafter with reference to the accompanying drawings for the embodiments of the present invention. Apparently, the described embodiments are only a portion of embodiments of the present invention, but not all the embodiments of the present invention. Based on the embodiments of the present invention, all other embodiments derived by persons of ordinary skill in the art without any creative efforts shall fall within the protection scope of the present invention.

Terms such as “first”, “second” and the like in the specifications, claims and the accompanying drawings of the present invention are intended to distinguishing different objects but are not intended to define a specific sequence. In addition, terms “comprise”, “include” and variations thereof are intended to define a non-exclusive meaning. For example, a process, method, system, product or device containing a series of steps or units is not limited to the listed steps or units, but optionally includes some other steps or units that are not listed, or optionally further includes other inherited steps or units of the process, method, product or device.

Term “embodiments” in this specification signifies that the specific characteristic, structure or feature described with reference to the embodiments may be covered in at least one embodiment of the present invention. This term, when appears in various positions of the description, neither indicates the same embodiment, nor indicates an independent or optional embodiment that is exclusive of the other embodiments. A person skilled in the art would implicitly or explicitly understand that the embodiments described in this specification may be incorporated with other embodiments.

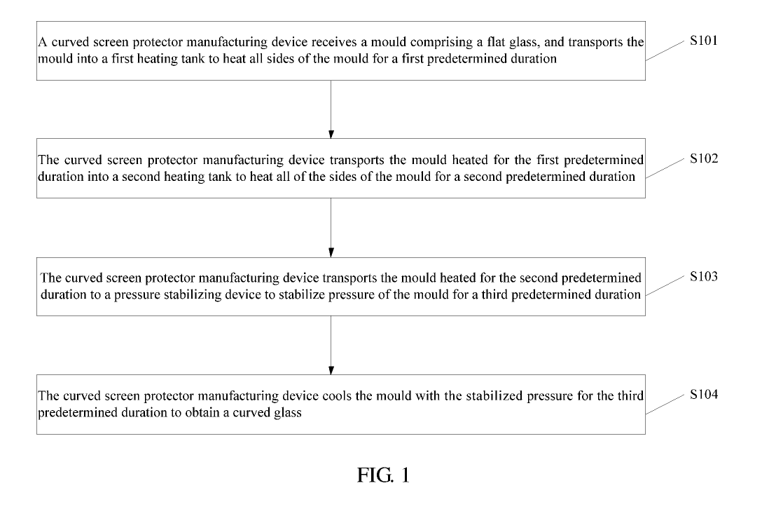

An embodiment of the present invention provides a method for manufacturing a curved glass for a screen protector. As illustrated in FIG. 1, the method comprises the following steps:

step S101: receiving, by a curved screen protector manufacturing device, a mould comprising a flat glass, and transporting the mould into a first heating tank to heat all sides of the mould for a first predetermined duration;

step S102: transporting, by the curved screen protector manufacturing device, the mould heated for the first predetermined duration into a second heating tank to heat all of the sides of the mould for a second predetermined duration;

step S103: transporting, by the curved screen protector manufacturing device, the mould heated for the second predetermined duration to a pressure stabilizing device to stabilize pressure of the mould for a third predetermined duration; and

step S104: cooling, by the curved screen protector manufacturing device, the mould with the stabilized pressure for the third predetermined duration to obtain a curved glass.

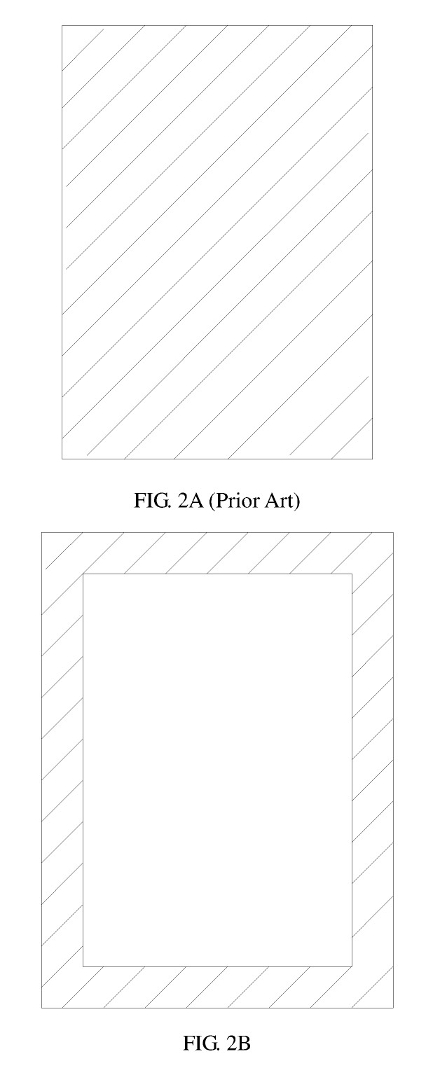

According to the technical solutions of the present invention, firstly all sides of a mould comprising a flat glass are heated; since only the sides of the mould are heated, when the sides are heated to the same temperature, the technical solutions have the advantages of short heating time, high heating efficiency and energy conservation because the heating area is small. FIG. 2A illustrates a heating area of a flat glass in the prior art. FIG. 2B illustrating a heating area of a flat glass according to the present invention. A comparison between FIG. 2A and FIG. 2B reveals that in the technical solutions of the present invention, the heating area, as represented by oblique lines, is much smaller than the conventional heating area. Accordingly, the technical solutions of the present invention have the advantages of small heating area, less heating energy and high heating speed. In addition, according to the present invention, the central area of the flat area is not heated, and therefore, the temperature in the central area is lower. As such, oxidation of the central area is slowed, and transparency of the curved glass is improved.

Preferably, step S104 may include the step of: subjecting, by the curved screen protector manufacturing device, the mould with the stabilized pressure to multi-stage cooling for the third predetermined duration to obtain the curved glass.

Preferably, the multi-stage cooling may be five-stage cooling or cooling with more than five stages.

The multi-stage cooling may include the step of: calculating, by the curved screen protector manufacturing device, a duration for the five-stage cooling according to a set temperature T corresponding to the second predetermined duration and a room temperature T0.

The calculation for the five-stage cooling may include the steps of: acquiring a temperature interval between the set temperature T and the room temperature T0, dividing the temperature interval into n groups, with each of the n groups comprising five temperature sub-intervals, and calculating a total duration of the five temperature sub-intervals of each of the n groups. The calculation for the total duration of the five temperature sub-intervals may include the steps of: calculating five sub-durations corresponding to the five temperature sub-intervals according to temperatures of the five temperature sub-intervals and temperature slopes corresponding to the five temperature sub-intervals; repeatedly calculating the total duration of the five temperature sub-intervals of each of the n groups by using a sum of the five sub-durations as the total duration of the five temperature sub-intervals to obtain n total durations; and selecting the five sub-durations of the five temperature sub-intervals corresponding to a minimum duration from the n total durations as the duration for the five-stage cooling.

The n groups with each comprising five temperature sub-intervals are obtained by: acquiring four border ranges of the five temperature sub-intervals; assigning a plurality of border points for the four border ranges according to a predetermined temperature interval; and subjecting the plurality of border points within the four border ranges to permutation and combination to obtain the n groups.

Hereinafter a practical example is given to describe how to obtain the n groups. The plurality of border points within the four border ranges are two border points, and the set temperature is 1° C. for example. For ease of description, the border point is represented by a digit, the border range of border point 1 is [1, 2], the border range of border point 2 is [3, 4], the border range of border point 3 is [5, 6], the border range of border point 4 is [7, 8]. In this case, the n groups may be the followings:

Group 1: T-1-3-5-7-T0; wherein T indicates the set temperature corresponding to the second predetermined duration, and T0 indicates the room temperature.

Group 2: T-1-3-6-7-T0; Group 3: T-1-3-6-8-T0; Group 4: T-1-4-5-7-T0; Group 5: T-1-4-5-8-T0; Group 6: T-1-4-6-7-T0; Group 7: T-1-4-6-8-T0; Group 8: T-2-3-5-7-T0; Group 9: T-2-3-6-7-T0; Group 10: T-2-3-6-8-T0; Group 11: T-2-4-5-7-T0; Group 12: T-2-4-5-8-T0; Group 13: T-2-4-6-7-T0; Group 14: T-2-4-6-8-T0. T-1 in Group 2 indicates a temperature interval between T and 1, the temperature slopes in the above various intervals may be obtained from a predetermined temperature slope list. The slope list may be obtained by experiments. The duration of the temperature interval is equal to (T−1)/k, wherein k indicates a slope of the temperature sub-interval (T−1) in the temperature slope list.

T and T0 may be defined by the user, and the four border ranges may also be defined by the user.

Durations of the n groups may be obtained by calculating the above cooling durations, and a high efficiency may be achieved by selecting a minimum duration.

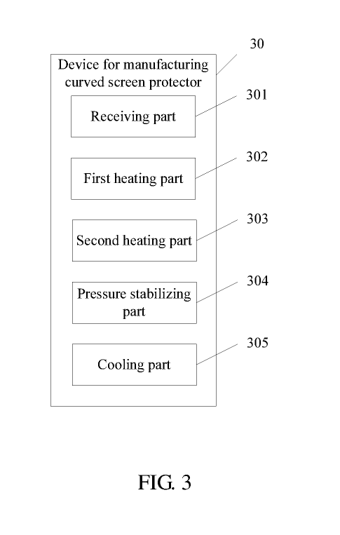

Referring to FIG. 3, FIG. 3 illustrates a device 30 for manufacturing a curved screen protector according to the present invention. The device 30 comprises a receiving part 301, a first heating part 302, a second heating part 303, a pressure stabilizing part 304 and a cooling part 305.

The receiving part 301 is configured to receive a mould comprising a flat glass. The first heating part 302 is configured to transport the mould into a first heating tank to heat all sides of the mould for a first predetermined duration. The second heating part 303 is configured to transport the mould heated for the first predetermined duration into a second heating tank to heat all of the sides of the mould for a second predetermined duration. The pressure stabilizing part 304 is configured to transport the mould heated for the second predetermined duration to a pressure stabilizing device to stabilize pressure of the mould for a third predetermined duration. The cooling part 305 is configured to cool the mould with the stabilized pressure for the third predetermined duration to obtain a curved glass.

Preferably, the pressure stabilizing part 304 is further configured to subject the mould with the stabilized pressure to multi-stage cooling for the third predetermined duration to obtain the curved glass.

Preferably, the multi-stage cooling is five-stage cooling or cooling with more than five stages.

Preferably, the cooling part 305 is further configured to calculate a duration for the five-stage cooling according to a set temperature T corresponding to the second predetermined duration and a room temperature T0.

Preferably, the cooling part is further configured to acquire a temperature interval between the set temperature T and the room temperature T0, divide the temperature interval into n groups with each comprising five temperature sub-intervals, and calculate a total duration of the five temperature sub-intervals of each of the n groups. The total duration of the five temperature sub-intervals is calculated by: calculating five sub-durations corresponding to the five temperature sub-intervals according to temperatures of the five temperature sub-intervals and temperature slopes corresponding to the five temperature sub-intervals; repeatedly calculating the total duration of the five temperature sub-intervals of each of the groups by using a sum of the five sub-durations as the total duration of the five temperature sub-intervals to obtain n total durations; and selecting the five sub-durations of the five temperature sub-intervals corresponding to a minimum duration from the n total durations as the duration for the five-stage cooling.

The n groups with each comprising five temperature sub-intervals are obtained by: acquiring four border ranges of the five temperature sub-intervals, assigning a plurality of border points for the four border ranges according to a predetermined temperature interval, and subjecting the plurality of border points within the four border ranges to permutation and combination to obtain the n groups.

Described above are only exemplary embodiments of the present invention, and are not intended to limit the scope of the present invention. Persons of ordinary skill in the art would appreciate that all or a part of processes implementing the above embodiments, and other equivalent variations made based on the claims of the present invention shall all fall within the scope of the present invention.

What is claimed is:

1. A method for manufacturing a curved glass for a screen protector, comprising steps of:
receiving, by a curved screen protector manufacturing device, a mould comprising a flat glass, and transporting the mould into a first heating tank to heat all sides of the mould for a first predetermined duration;
transporting, by the curved screen protector manufacturing device, the mould heated for the first predetermined duration into a second heating tank to heat all of the sides of the mould for a second predetermined duration;
transporting, by the curved screen protector manufacturing device, the mould heated for the second predetermined duration to a pressure stabilizing device to stabilize pressure of the mould for a third predetermined duration; and
cooling, by the curved screen protector manufacturing device, the mould with the stabilized pressure for the third predetermined duration to obtain a curved glass.

2. The method according to claim 1, wherein the step of cooling, by the curved screen protector manufacturing device, the mould with the stabilized pressure for the third predetermined duration to obtain a curved glass comprises a step of:
subjecting, by the curved screen protector manufacturing device, the mould with the stabilized pressure to multi-stage cooling for the third predetermined duration to obtain the curved glass.

3. The method according to claim 2, wherein the multi-stage cooling is five-stage cooling or cooling with more than five stages.

4. The method according to claim 3, wherein the step of subjecting, by the curved screen protector manufacturing device, the mould with the stabilized pressure to multi-stage cooling for the third predetermined duration to obtain the curved glass comprises a step of:
calculating, by the curved screen protector manufacturing device, a duration for the five-stage cooling according to a set temperature corresponding to the second predetermined duration and a room temperature.

5. The method according to claim 4, wherein the step of calculating, by the curved screen protector manufacturing device, a duration for the five-stage cooling according to a set temperature corresponding to the second predetermined duration and a room temperature comprises steps of:
acquiring a temperature interval between the set temperature and the room temperature;
dividing the temperature interval into n groups, with each of the n groups comprising five temperature sub-intervals; and
calculating a total duration of the five temperature sub-intervals of each of the n groups,
wherein the step of calculating a total duration of the five temperature sub-intervals of each of the n groups comprises steps of:
calculating five sub-durations corresponding to the five temperature sub-intervals according to temperatures of the five temperature sub-intervals and temperature slopes corresponding to the five temperature sub-intervals;
repeatedly calculating the total duration of the five temperature sub-intervals of each of the n groups by using a sum of the five sub-durations as the total duration of the five temperature sub-intervals to obtain n total durations; and
selecting the five sub-durations of the five temperature sub-intervals corresponding to a minimum duration from the n total durations as the duration for the five-stage cooling,
wherein the n groups are obtained by steps of:
acquiring four border ranges of the five temperature sub-intervals;
assigning a plurality of border points for the four border ranges according to a predetermined temperature interval; and
subjecting the plurality of border points within the four border ranges to permutation and combination to obtain the n groups.

6. A device for manufacturing a curved screen protector, comprising:
a receiving part, configured to receive a mould comprising a flat glass;
a first heating part, configured to transport the mould into a first heating tank to heat all sides of the mould for a first predetermined duration;
a second heating part, configured to transport the mould heated for the first predetermined duration into a second heating tank to heat all of the sides of the mould for a second predetermined duration;
a pressure stabilizing part, configured to transport the mould heated for the second predetermined duration to a pressure stabilizing device to stabilize pressure of the mould for a third predetermined duration; and
a cooling part, configured to cool the mould with the stabilized pressure for the third predetermined duration to obtain a curved glass.

7. The device according to claim 6, wherein the pressure stabilizing part is further configured to subject the mould with the stabilized pressure to multi-stage cooling for the third predetermined duration to obtain the curved glass.

8. The method according to claim 7, wherein the multi-stage cooling is five-stage cooling or cooling with more than five stages.

9. The device according to claim 8, wherein the cooling part is further configured to calculate a duration for the five-stage cooling according to a set temperature corresponding to the second predetermined duration and a room temperature.

10. The device according to claim 9, wherein the cooling part is further configured to acquire a temperature interval between the set temperature and the room temperature, divide the temperature interval into n groups, with each of the n groups comprising five temperature sub-intervals, and calculate a total duration of the five temperature sub-intervals of each of the n groups,
wherein the total duration of the five temperature sub-intervals is calculated by calculating five sub-durations corresponding to the five temperature sub-intervals according to temperatures of the five temperature sub-intervals and temperature slopes corresponding to the five temperature sub-intervals, repeatedly calculating the total duration of the five temperature sub-intervals of each of the n groups by using a sum of the five sub-durations as the total duration of the five temperature sub-intervals to obtain n total durations, and selecting the five sub-durations of the five temperature sub-intervals corresponding to a minimum duration from the n total durations as the duration for the five-stage cooling,
wherein the n groups are obtained by acquiring four border ranges of the five temperature sub-intervals, assigning a plurality of border points for the four border ranges according to a predetermined temperature interval, and subjecting the plurality of border points within the four border ranges to permutation and combination to obtain the n groups.
